(19) United States
(12) Patent Application Publication
(10) Pub. No.: US 2019/0054627 A1
(43) Pub. Date: Feb. 21, 2019

(54) AUXILIARY ROBOT WITH ARTIFICIAL INTELLIGENCE

(71) Applicant: DB1 GLOBAL SOFTWARE S/A, Maringa (BR)

(72) Inventor: Marco Diniz Garcia Gomes, MARINGA (BR)

(21) Appl. No.: 15/956,077

(22) Filed: Apr. 18, 2018

(30) Foreign Application Priority Data
Aug. 17, 2017 (BR) BR 102017016910-3

(51) Int. Cl. B25J 11/00; B25J 9/00; B25J 13/08; B25J 19/02

(52) U.S. Cl. CPC B25J 11/0015; B25J 9/0012; B25J 9/0021; B25J 19/023; B25J 13/081

(57) ABSTRACT

The following abstract for invention refers to the development of an auxiliary robot with artificial intelligence, performing several tasks and managing teams, said robot (10) having movable head (1), rotating torso (30), movable arms (11 and 12), a hinged hand (18) and hand having a laser system (19), the torso (30) being rotatable over a base (38), being able of interacting with the user (43) by means of voice commands (44), and can also receive settings, personalization and manual control (45) by means of a Web interface (46), by means of a computer (47), wherein said computer can request data (48) and synchronize the robot (10), which can be controlled by means of wireless connection by some application (APPs) to carry out interactions (49).

### TECHNICAL FIELD

The following specification for invention refers to the development of a robot provided with artificial intelligence (AI), with natural speech in Portuguese, voice, gesture and expression recognition, capable of being configurable and having its actions customized, the development of which involves innovative and emerging technologies and concepts, such as, Raspberry Pi®, Arduino®, “Internet of Things” and cognitive voice interpretation (such as Siri®, Cortana® and Google Now®)

Two important concepts must be interpreted in a coherent way for a complete understanding of the proposed development.

Artificial intelligence is a machine capable of thinking, which in any given task would mean analyzing data and according to the results making decisions, basically what the human mind does. Automation is simply a process of completing a task with little or no human intervention; it is a preprogrammed process that will be repeated constantly. Automation is not artificial intelligence.

Artificial intelligence refers to intelligence, not to consciousness. “Intelligence is the ability to solve problems in any domain. Consciousness is something that people claim to have, it has no practical application, it does not do anything, in fact we cannot even detect it, therefore, it is not a scientific concept” (Yampolskiy, R.—CyberSecurity Lab).

As a corollary of this statement, one always imagines the artificial intelligence applied in a humanoid-looking robot, when, in most cases, AI is hidden in several devices, such as, for example, the voice recognition systems for client support.

### STATE OF THE ART

Auxiliary robots having artificial intelligence are already a reality in several levels.

An example of this are autonomous personal robots for services, such as, “home care.” A robot with these characteristics can be seen in U.S. Pat. No. 8,359,122.

A multifunctional intelligent robot is described in CN 102672702 and comprises a head, a body, two hands, two traveling portions, a monitor (tablet) and a projector. The two hands are arranged on two sides of the body, respectively, the two traveling parts are arranged on two sides of the lower part of the body, the monitor is arranged in front of the head and the projector is arranged on the back of the head. The intelligent multifunctional robot can be used as a learning tool for children through a pre-installed educational learning program, it can be used as a mobile monitoring device by means of a camera of the tablet and the traveling portions, and it can be used as a videoconference device through the tablet and projector, such that multiple objectives are attained by the multifunction intelligent robot.

Document 9299022 discloses apparatuses and methods for an extensible robotic device having artificial intelligence and receptive to training controls. In one implementation, it is disclosed a modular robotic system that allows the user to completely select the architecture and set of capabilities of its robotic device. The user can add/remove modules, since their respective functions are necessary/avoided. In addition, the artificial intelligence is based on a neuronal network (for example, neural network) and a behavioral control structure that allows the user to train a robotic device in a way conceptually like the way with which it is trained a domesticated animal, such as a dog or cat. The control structure of trainable behavior is based on the artificial neural network, which simulates the neural/synaptic activity of the brain of a living organism.

A system and method for electing a leader in a group of robots is described in WO 2009040777, which includes assigning tasks to a group of robots to collect information. A leader is elected by designating each robot as a leader and comparing a criterion related to the information collected among the robots of the group to determine a non-leader robot in each comparison until a single leader is determined due to being a remaining robot designated as a leader.

### Problem of the Technique

The market already knows the chatbots tools (Hubot®, Slack®, Hipchat®, Api.ai®), which are tools for automation and interaction with the user through natural text. Also, virtual assistants (Google Now®, Alexa®) that allow the user to have a more humanized interaction through natural speech also allow, through programming, to be customized to meet specific needs.

However, we did not observe an auxiliary robot with programmable artificial intelligence to perform several activities, both in the domestic and corporate environments. In this way, the proposed robot can be considered a member of a team, can work as an employee, besides the capacity for interaction arising from artificial intelligence.

### Proposed Solution

The proposed robot aims to assist teams in several activities, such as software development, language teacher, interpreter, team coach, product mentor, performing reading of project indicators, producing alerts on the status of development environments, homologation and production, deadlines and delays, performing pending tasks, checking for open errors, bugs identified by the homologation or the client, performing monitoring and notification about the steps of software delivery (code publication, code compilation, unit tests, publication), informing about the presence and absence of team members, and keeping the team informed about important aspects of project prosecution and delivery.

To perform its functions, the auxiliary robot is provided with artificial intelligence, whose objective is to improve the efficiency and performance of the teams where it is acting.

The idea of the auxiliary robot (TinBot) came from the fact that a machine giving orders and pointing errors causes less negative emotional impact than another human being performing the same actions. Having this in mind, the auxiliary robot is free to charge the team with the necessary firmness, without causing dislike.

### SUMMARY

Thus, due to considerations pertaining to the state of the art discussed above, it is one of the objectives of the present invention to develop a robot that behaves as an auxiliary or even team mentor, and which presents the following differences with respect to the devices known: communication through voice (it gives more naturality and practicality in the interaction), independent device (as it is a physical robot, the user does not have to access a computer and log in an account in order to interact with the bot, being enough to use speech, as a real human being would do), it features different expressions and movements (it has several movements and facial expressions, which allows a more ludic communication and more like human communication), it provides a boost in attention (as it is a physical device, a robot, when it sends a notification or takes some action, it is more prone to retain the attention of all members of a team and at the same time when in chatbots would depend on the member accessing the system and reading the notification).

As it has several movements and facial expressions the robot allows a more ludic and more like a human communication that uses gestures and expressions to boost the message transmitted.

As the robot was designed to be multifunctional, it allows a much easier integration with software, which in virtual assistants would require extensive programming work.

In order to control the robot's actions, which include movement, lighting, speech, and facial expressions, a proprietary control language (TinBot Control Tiny Code) has been developed to allow that even non-technical users can create complex actions for control of the robot with the minimum code possible, and allow the integration of chatbots functions with a physical body, because chatbots, in general, interact only through text, with the robot one can join the usefulness and versatility of a chatbot with movements and facial expressions, making the use experience more ludic and humanized.

### DESCRIPTION

The characterization of the present invention is made by means of representative drawings of the auxiliary robot having artificial intelligence, such that the device can be fully reproduced by suitable technique, allowing full characterization of the functionality of the claimed object.

From the elaborated figures that express the best form or preferential form of realizing the product now conceived, it is grounded the descriptive part of the specification through a detailed and consecutive numbering, where the same clarifies aspects that may be implied by the representation adopted, such as to clearly determine the protection now sought.

These figures are merely illustrative, and may present variations, if they do not depart from what was initially claimed.

In this case you have:

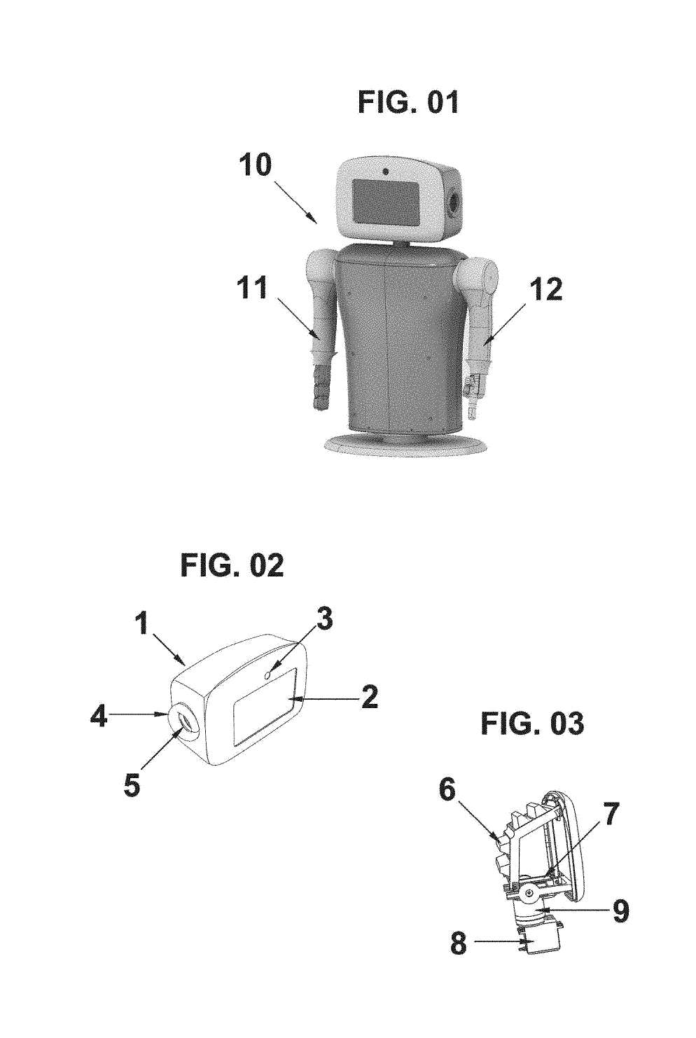

FIG. 1 shows a perspective view of the robot in its presentation form;

FIG. 2 shows a perspective view of the head;

FIG. 3 shows internal details of the head;

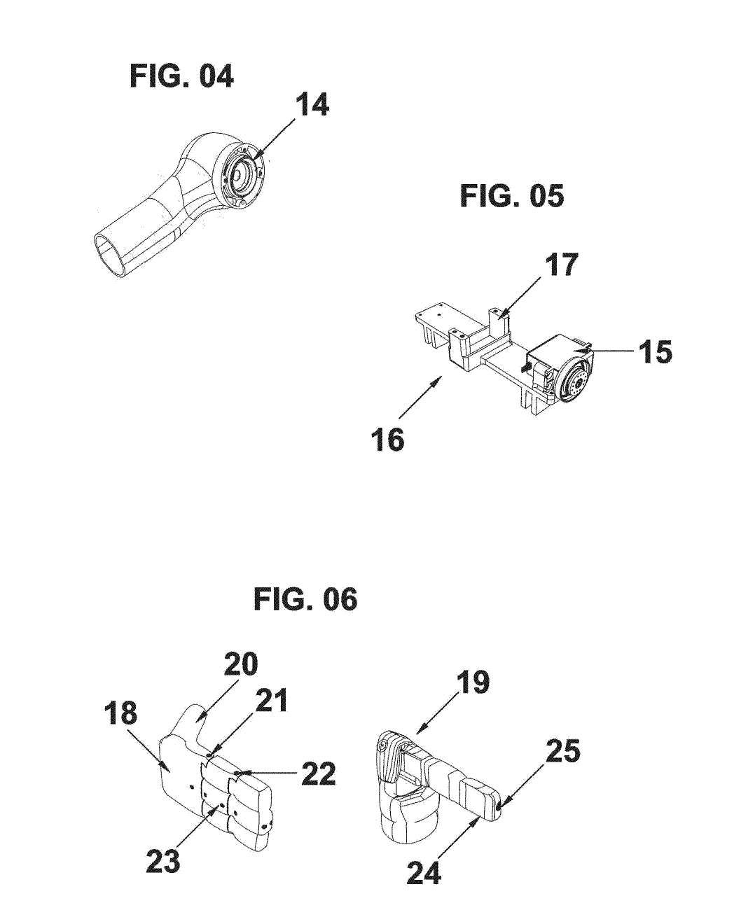

FIG. 4 shows the robot arm;

FIG. 5 shows the clavicle;

FIG. 6 shows the hands;

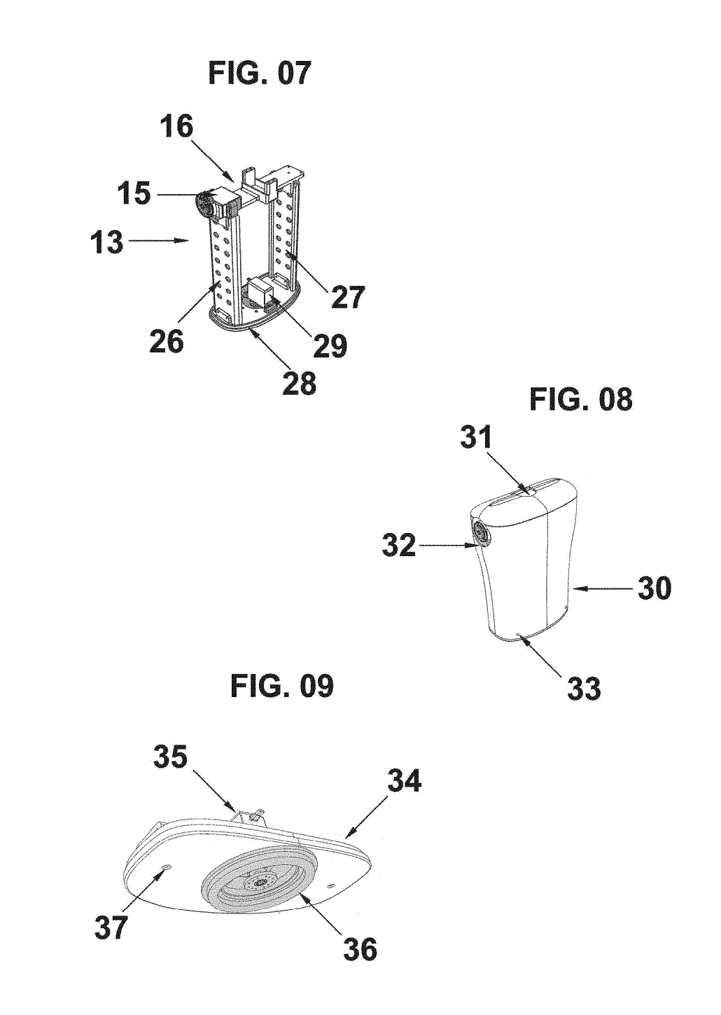

FIG. 7 shows the inner base;

FIG. 8 shows the outer enclosure;

FIG. 9 shows the upper base;

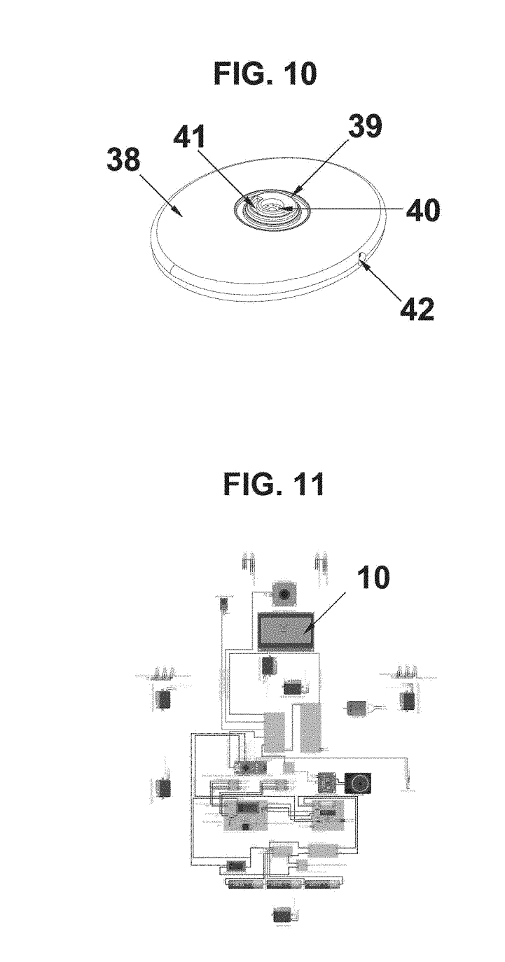

FIG. 10 shows the upper base;

FIG. 11 shows the electromechanical structure of the robot; and

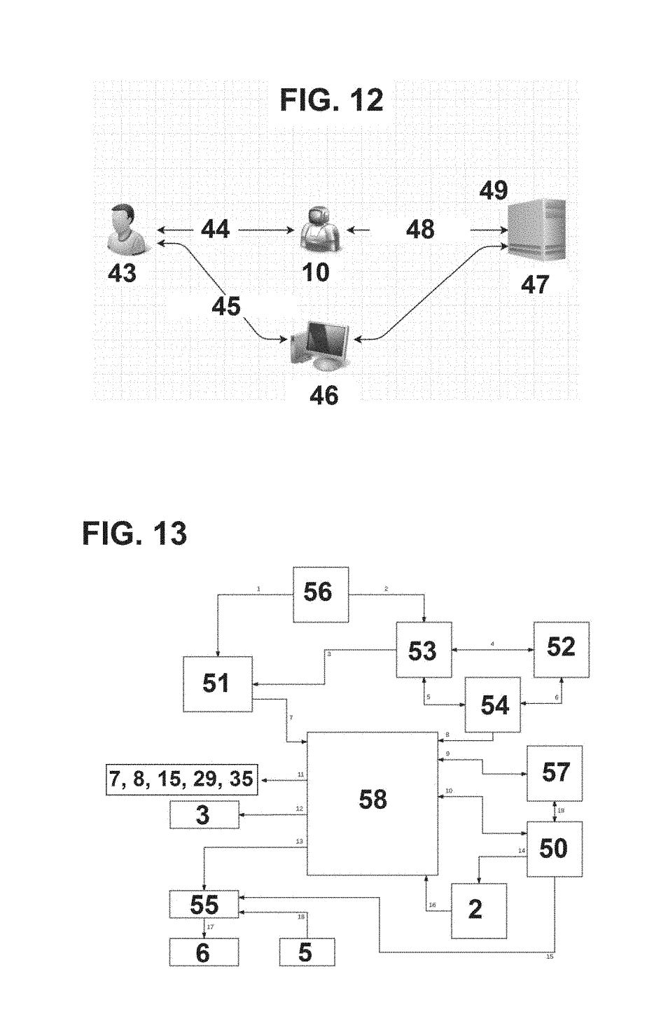

FIG. 12 shows the communication diagram of the robot

FIG. 13 shows the diagram of the components and connections of the robot.

The robot has a head (1) comprised of a touch screen (2), carrying a front camera (3) for photo and facial recognition, transparent ears illuminated by colored LEDs (4) with blinking/rotating effects, and two microphones (5), with voice and speech recognition, with stereo pickup for audio location.

Internally to the head, there is a set of four loudspeakers (6) arranged at the rear portion, with a servomotor (7) for moving the head (1) on the vertical axis, another servomotor (8) for movement of the head (1) on the horizontal axis, the neck (9) connecting the horizontal axis to the vertical axis.

The robot (10) has two arms (11 and 12) attached to the inner base (13) by means of a plastic bearing (14) which connects each arm with its respective servomotor (15), the bearings (14) allowing rotation of 180° upwards, with return to the rest position.

The arms (11 and 12) are connected to the clavicle (16) containing the support (17) for the mechanism for moving the neck by the servomotor (8), and in the clavicle (16) it is positioned each servomotor (15) for moving the respective arms.

Each of the arms (11 and 12) of the robot (10) is provided with its own hand (18 and 19) with its own and independent movements, where the right hand (18) is provided with open and close movement with the thumb raised (20) by the movement shafts (21 and 22), in addition to containing guides of nylon line (23) which provide the opening and closing movement, and the left hand (19) features the pointed indicator (24), counting with an aperture (25) for outputting the laser beam.

The inner base (13) is provided with two supporting walls (26 and 27) which rest on the lower base (28) and support the clavicle (16) containing each servomotor (15) of each of the arms (11 and 12), and close to the lower base (28) it is seated the servomotor (29) for rotating torso (30) attached to the base by means of screws.

The torso 30 or outer enclosure has an upper outlet (31) for the neck (9), the outlets (32) for the arms (11 and 12) and attachment points (33) with which it couples the torso to the lower base (28).

The upper base (34) contains a servomotor (35) for rotating the torso (30) 270°, a plastic bearing (36) connecting the lower base and attachment points (37) to the inner walls (26 and 27).

The lower base (38) features a plastic bearing (39) for joining with the upper base (34), attachment point (40) of the servomotor (29), space (41) for moving the power cable and the plug (42) for power.

The robot comprises interfaces for interaction through the touch screen colored TFT screen, stereo microphone for speech understanding, loudspeaker for speech synthesis and integrated camera for photography, identification and analysis of environments.

For movement of the robot, the robot is equipped with a right arm with 180° rotation, left arm with 180° rotation, hand in right arm with two joints and open/close movement, torso with 270° rotation, head with 180° rotation on the X axis and 80° on the Y axis.

Illumination is achieved by means of four RGB LEDs on each of the ears and a red dot laser module on the left hand.

The main electronic modules are: an Intel Atom x86 computer (50) having integrated memory, storage, Wi-Fi and Bluetooth, two voltage regulator modules (51) for main powering of computer (50) and other electronic components, a touch TFT screen, three batteries (52) with a capacity of 3400 mah each, a protective and balancing module for batteries (53), sensor of load reading (54) of batteries, an audio amplifier 12v/20w/(55), power source (56), Arduino (57) and main board (58).

The robot (10) interacts with the user (43) by means of voice commands (44), and may also receive settings, personalization and manual control (45) via the Web interface (46) by means of a computer 47, wherein this computer may request data (48) and synchronize the robot (10), which can be controlled by means of wireless connection by some application to perform interactions (49), such as Skype, Instagram etc.

The following table shows the description of the connections between the modules:

| | |
|---|---|
| 1 | Power to system 6 V |
| 2 | Power to system 12 V; Charge the batteries |
| 3 | Power to system 6 V |
| 4 | Charge and protect the batteries; Power to the system |
| 5 | Current reading between the batteries and the balancer |
| 6 | Current reading between the batteries and the balancer |
| 7 | Power supply 6 V |
| 8 | Battery level information for Arduino |
| 9 | Communicating between Arduino and peripherals of the |
| | system and with the computer; Over current and short circuit |
| | protection |
| 10 | Protection and on-off control of communication with USB |
| | devices; |
| | Computer power supply 5 V; |
| | Reading of on/off status of the computer; |
| | On/off button of computer |
| 11 | Transferring the Arduino commands to the servos; |
| | Protection against over-current |
| 12 | USB communication with the computer |
| 13 | Power supply 12 V |
| 14 | Sending image signal to the screen; |
| | Reception of touch signal from screen |
| 15 | Audio signal |
| 16 | Power supply |
| 17 | Audio signal |
| 18 | Reception of audio signal |

1- AUXILIARY ROBOT WITH ARTIFICIAL INTELLIGENCE, characterized in that it has movable head (1), rotatable torso (30), movable arms (11 and 12), articulated hand (18) and hand with laser system (19), the torso (30) being rotatable over a base (38).

2- AUXILIARY ROBOT according to claim 1 and characterized in that the head (1) is comprised of a touch screen (2) carrying a front camera (3), transparent ears illuminated by colored LEDs (4), with effects of blinking/rotation and two microphones (5), with stereo pickup for audio location.

3- AUXILIARY ROBOT according to claim 1 and characterized in that it has, internally to the head, a set of four loudspeakers (6) arranged in the rear part, having a servomotor (7) for moving the head (1) on the axis, another servomotor (8) for moving the head (1) on the horizontal axis, the neck (9) connecting the horizontal axis to the vertical axis.

4- AUXILIARY ROBOT according to claim 1 and characterized in that the robot (10) has two arms (11 and 12) attached to the inner base (13) by means of a plastic bearing (14) which connects each arm with their respective servomotor (15), the bearings (14) allowing rotation from 180° upward, with return to the rest position.

5- AUXILIARY ROBOT according to claim 1 and characterized in that the arms (11 and 12) are connected to the clavicle (16) containing the support (17) for the mechanism of movement of the neck by the servomotor (8), wherein in the clavicle (16) each servomotor (15) is positioned to move the respective arms (11 and 12).

6- AUXILIARY ROBOT according to claim 1 and characterized in that the arms (11 and 12) of the robot (10) are provided with respective hand (18 and 19) with own and independent movements, wherein the right hand (18) is provided with open/close movement with the thumb lifted (20) by the moving axes (21 and 22), in addition to containing guides of nylon line (23) which provide the opening and closing movement, and the left hand (19) features the indicator pointed (24), having an aperture (25) for outputting the laser beam.

7- AUXILIARY ROBOT according to claim 1 and characterized in that the inner base (13) is provided with two support walls (26 and 27) which rest on the lower base (28) and support the clavicle (16) that contains each servomotor (15) of each of the arms (11 and 12), and close to the lower base (28) it is seated servomotor (29) of the torso (30) attached to the same by means of screws.

8- AUXILIARY ROBOT according to claim 1 and characterized in that the torso (30) or outer enclosure features the upper outlet (31) for the neck (9), the outlets (32) for the arms (11 and 12) and attachment points (33) with which it is attached the torso to the lower base (28).

9- AUXILIARY ROBOT according to claim 1 and characterized in that the upper base (34) contains a servomotor (35) for rotating the torso (30) 270°, a plastic bearing (36) connecting with the lower base and attachment points (37) to the inner walls (26 and 27).

10- AUXILIARY ROBOT according to claim 1 and characterized in that the lower base (38) features a plastic bearing (39) for joining with the upper base (34), the attachment point (40) of the servomotor (29), space (41) for power cable movement and plug (42) for power supply.

11- AUXILIARY ROBOT according to claim 1 and characterized in that the robot (10) interacts with the user (43) by means of voice commands (44), and can also receive configuration, personalization and manual control (45) by means of Web interface (46), by means of a computer (47), wherein said computer can request data (48) and synchronize the robot (10), which can be controlled by means of wireless connection by some application (APPs) to perform interactions (49).

12- AUXILIARY ROBOT according to claim 1 and characterized by having a computer (50) with integrated memory, storage, Wi-Fi and Bluetooth, two voltage regulator modules (51) for powering the main computer (50) and other electronic components, a touch TFT screen (54), three batteries (52), one protector and balancer module of batteries (53), sensor of load reading (54) of batteries, an audio amplifier (55), a source (56), Arduino (57) and main board (58).
